(19) United States
(12) Patent Application Publication
(10) Pub. No.: US 2024/0331429 A1
(43) Pub. Date: Oct. 3, 2024

(54) SYSTEM AND METHOD FOR AUTO-GROUPING AND BULK-SIGNING OF PRE-APPROVED DOCUMENTS

(71) Applicant: Certinal Software Private Limited, Mumbai (IN)

(72) Inventor: Krishnendu Chattopadhyaya, Mumbai (IN)

(73) Assignee: Certinal Software Private Limited, Mumbai (IN)

(21) Appl. No.: 18/620,525

(22) Filed: Mar. 28, 2024

(30) Foreign Application Priority Data
Mar. 29, 2023 (IN) 202321022985

(51) Int. Cl. G06V 30/32; G06Q 50/18; G06V 30/19

(52) U.S. Cl. CPC G06V 30/36; G06Q 50/18; G06V 30/19107; G06V 30/1916; G06V 2201/10

(57) ABSTRACT

A system (1) and method for auto-grouping and bulk signing of pre-approved documents (9a), wherein an admin (2) enables the workflow (10) options, a sender (3) sends a pre-approved document (9a) to be signed, using an input device (6) where a signer (4) employs a workflow (10) from an e-signature feature (15), through a processing means (7) and sends the signed documents (9b) to a recipient (5) using an output device (8), and the pre-approved documents (9a) are grouped using the metadata (14) and the signed documents (9b) are stored in at least one hosting server (16), so as to facilitate the auto-grouping, and individual as well as bulk signing of the pre-approved documents (9a) within the same group, using an e-signature feature of the present system (1) by following the defined that enables applying individual signature and bulk signature respectively, to the pre-approved documents (9a).

### CROSS-REFERENCE TO RELATED APPLICATION

The instant application claims priority to Indian Patent Application Serial No. 202321022985, filed Mar. 29, 2023, the entire specification of which is expressly incorporated herein by reference.

### FIELD OF THE INVENTION

The present invention relates to electronic signing of electronic documents. More particularly, the present invention relates to a system and method for auto-grouping of the pre-approved documents and applying a bulk signing workflow enabling bulk signing of the pre-approved documents.

### BACKGROUND OF THE INVENTION

Documents act as an important aspect of daily transactions, where the document implies either a piece of written, printed or electronic matter that serves the purpose of an official record, provide information or sometimes act as evidence. Until lately, the traditional methods included physical sharing and signing of documents by each of the concerned authority. The document exchange to every concerned person for signing the documents becomes a prolonged and cumbersome process thereby delay in furnishing such signed documents, making the system more inconvenient in case of time-bound transactions.

However, in today's world of online transactions, it becomes a mandate to switch to electronic and digital documents, especially for the business purposes. Signing the documents electronically is a time and effort saving method. An electronic document may include healthcare records, personnel records, employment related applications, contracts, non-disclosure agreements, sales agreements, purchase orders, digital invoices and so on. Such documents usually are required to be signed by one or more senior executives for approval or for validating the legality of the documents.

In the current business scenario, the senior executives in an organization needs to sign on multiple documents on a daily basis of a certain legal entity, business unit and document type, which are mostly prior reviewed by their internal department like the legal and business team, before the signature workflow request is sent out by a sender to the senior executive for their signature. In the case when such multiple documents of a certain legal entity, business unit and document type, accumulate in the senior executive's email from different clients on a per day basis, fifty or more odd emails gets accumulated. With the currently available systems and methods, the senior executive has to review and sign each such document one by one from different email notification links. This is a very cumbersome process, which cause delays and inefficiency in getting the documents signed off especially when the documents were pre-reviewed by internal legal and business teams.

### PRIOR ART

U.S. Pat. No. 9,547,879 discloses an electronic document processing system, an electronic document generation mechanism, an encrypted digital certificate generator, a tool for coordinating the processing of e-documents, a packaging mechanism for finalizing and authenticating electronic documents, a tracking log for recording relevant electronic document information, and a transferring the ownership of electronics documents, wherein the system includes application of watermark seal or signature line for confirming a document's signing within the view, further also disclosing a system, software program, and method for generating electronic documents, coordinating the signing of electronic documents, digitally authenticating and certifying electronic documents, and organizing electronic documents individually for retrieval and transfer in a mortgage closing and/or other financial services application.

U.S. Pat. No. 9,325,508 discloses a system and method for signing and authenticating electronic documents using public key cryptographic applied by one or more server computer clusters operated in trustworthy manner, which may act in cooperation with trusted components controlled and operated by the signer. The system employs a presentation authority for presenting an unsigned copy of e-document to a signing party and a signature authority for affixing an electronic signature to the document thereby signing it electronically, through an applet for a signing party's computer that communicates with the signature authority.

All the above patents comprise of the system and method to present the documents individually to be digitally signed and authenticated by the concerned authority. However, in a scenario wherein the documents are already checked and approved and such large numbers of similar documents are to be signed, the priorly disclosed methods do not provide any method to club the documents and sign such multiple documents in single step.

To overcome the evident technical drawbacks of the already known methods as stated above, the present invention provides a technical solution to the same.

### Definitions

For the purpose of the present invention, the various terms used throughout the invention are defined as follows:

“Document” refers to an electric document.

“Pre-approved documents” refers to the documents which are internally vetted and approved by an internal legal team for sign off.

“Admin” refers to any person having access for modifying the system settings, allowing him to modify, enable or disable any features of the system as per the transaction requirement of the sender/user.

“Sender” refers to the person who is the originator of the document i.e. the person who sends the document to be electronically signed to the signer, defines the signing workflow and also decides the method to be used for signing the documents.

“Signer” refers to any person who is required to check the details and particulars mentioned in a document and is authorized to sign the documents for providing approval or validating the documents, and may include but not limited to, a manager or a senior executive so to say.

“Internal signer” refers to any person who is a signer belonging to the same organization as that of the sender of the document.

“External signer” refers to any person who is a signer belonging to a different organization than that of the sender of the document.

“Senior executive” refers to any person who is authorized for approving and signing any or all of the documents to validate the documents, where the senior executives include, not limited to, the individuals like the manager, member of the legal team or head of department to name a few.

“Network” refers to a group or a system also including but not limited to interconnected people or things.

“Input device” and “output device” refers to anything including, but not limited to a computer system, a mobile device, a user interface, screens, servers like hosting servers and more, that enable access to any centralized resource, system, or service within a network.

“Metadata” refers to collective information about multiple databases related to different fields, such as entity based, business unit based, contract types including and not limited to—vendor contracts, customer contracts, partner contracts, non-disclosure agreements (NDAs), value-based contracts and any additional user specific data, where such metadata is used to segregate a large number of documents into relevant groups for ease in the signing of large numbers documents.

“Signature” refers to an electronic signature that is applied using an electronic device such as a computer, mobile devices, smart cards, and the like, to authenticate the signatory and certify the integrity of the document.

“Workflow” refers to a stepwise method to be performed for obtaining a specific output using a defined system.

### OBJECTIVES OF THE INVENTION

An object of the present invention is to provide a system and method for electronic signing of electronic documents.

Yet another object of the present invention is to provide a system and method for auto-grouping of pre-approved documents.

Another object of the invention is to provide a system and method enabling bulk signing of pre-approved documents.

Yet another object of the present invention is to provide an alternative method for individual e-signing of pre-approved documents.

Yet another object of the present invention is to provide a metadata field mapping for auto-grouping of pre-approved documents.

Yet another object is to provide a time-saving, effortless, convenient, one-click-approach method for signing multiple documents simultaneously.

### SUMMARY OF THE INVENTION

The present invention relates to electronic signing of electronic documents and in particular, to a system (1) and method for auto-grouping of the pre-approved documents and applying a bulk signing workflow enabling bulk signing of the pre-approved documents, and also providing an alternative workflow for individual signing of pre-approved documents.

In one aspect, the system (1) and method of the present invention provides a unique workflow (10) to select and sign multiple documents which belong to the same group and were pre-approved by internal teams wherein the grouping of same documents is determined by the system (1) based on standard grouping metadata (14) fields, allowing the signer (4) to alternatively opt for “individual signing” or “bulk signing” of a group of similar documents.

In another aspect, the system (1) and method of the present invention provides a workflow-I for individual signing of the pre-approved documents, where the signer (4) has to select the “review and sign” option enabling the signer (4) to sign individual documents through a separate email link received for every pre-approved document.

In yet another aspect, the system (1) and method of the present invention provides a workflow-II for bulk signing of pre-approved documents placed within a particular group using the metadata (14) field mapping of the e-signature feature (15), wherein the system (1) and method provided herein either allows bulk signing using “select all” option or “selective signing” for signing all pre-approved documents or selectively signing multiple pre-approved documents respectively.

In yet another aspect, the system (1) and method of the present invention provides a time-saving, effortless, convenient and one-click-approach method for electronic signing of multiple documents simultaneously.

### BRIEF DESCRIPTION OF THE DRAWINGS

FIG. 1 illustrates a schematic view of the system of the present invention.

FIG. 2 illustrates a schematic view of various elements of the system and their arrangement over a network.

FIG. 3 illustrates a schematic view of the sequential elements defining a concise workflow for electronically signing documents using a method of the present invention.

FIG. 4 illustrates a schematic view of a flowchart involving the sequential steps of electronic signing of the pre-approved documents wherein the alternative workflows for signing the documents are defined in detail.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

Electronic signing or e-signing of documents has become an integral part of business, where documents to be signed are flooded in the email inbox of the authorized persons such as the senior executives, managers and the like, making it a complicated and time-consuming process to review every document and sign them one by one. To assist such senior executives as an internal signer (4), a system (1) and method of the present invention provides a unique workflow (10) to select and sign multiple documents which belong to the same group and were pre-approved by internal teams using an eSignature feature, wherein the grouping of same documents is determined by the system (1) based on standard grouping metadata (14) fields, allowing the signer (4) to alternatively opt for “individual signing” or “bulk signing” of a group of similar documents.

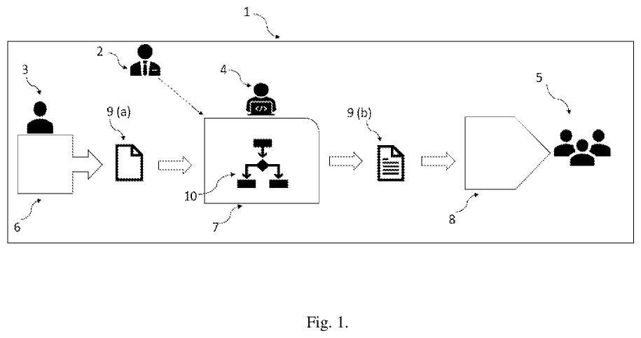

The system (1) and method of the present invention can be understood more clearly from the various embodiments emphasizing the various aspects of the invention with reference to the drawings included with the present description. An embodiment of the invention discloses the present system (1) as illustrated in FIG. 1., that comprises an admin (2), a sender (3) of the documents, a signer (4) of the documents, a recipient (5) of the documents, an input device (6), a processing means (7) employing a workflow (10), an output device (8), a pre-approved document (9a) and a signed document (9b), where the admin (2) enables the workflow (10) options, the sender (3) sends a pre-approved document (9a) to be signed, using an input device (6) where a signer (4) employs a workflow (10) from an e-signature feature (15), through a processing means (7) and sends the signed document's (9b) to a recipient (5) using an output device (8).

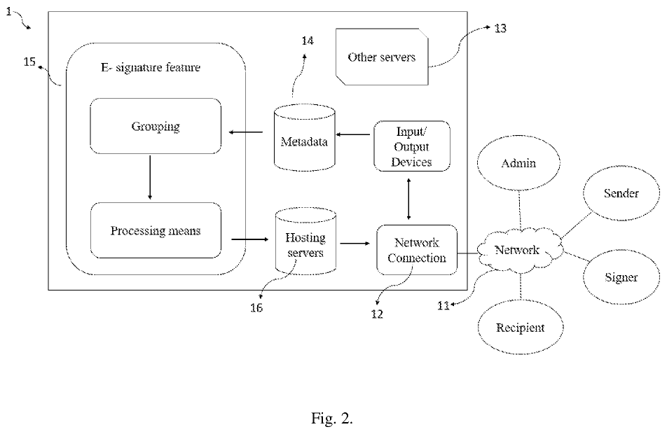

Additionally, an embodiment of the invention as illustrated in FIG. 2. also includes a network (11) allowing the admin (2), sender (3), signer (4) or recipient (5) to interact with the system (1) through a network connection (12), where the system (1) also includes metadata (14), multiple servers (13), input/output devices (6, 8) and an e-signature feature (15), where the metadata (14) is a collective information of one or more databases based on which the similar documents can be added in one group and the server includes at least one hosting server (16) for storing documents.

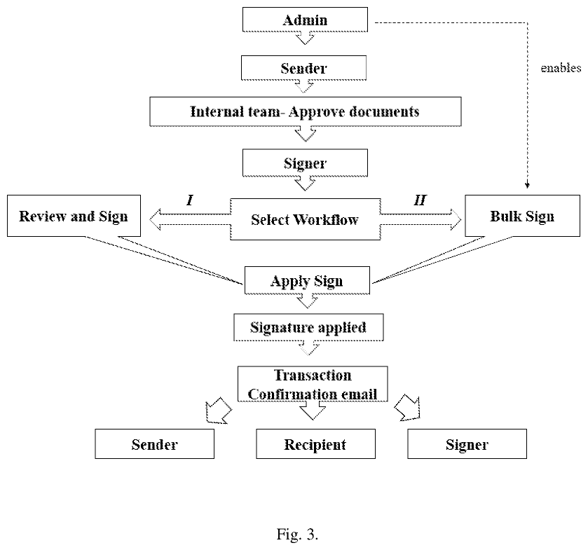

In all the preferred embodiments of the present invention described herein, a method for electronically signing documents using an e-signature feature (15) of the present system (1) follows a defined workflow (10) as illustrated in FIG. 3, comprising the steps as follows:

The admin (2) initially turns on the “bulk sign” option from the system (1) settings enabling the user/sender (3) to pre-decide the workflow (10) to be followed while processing the transaction.

The sender (3) adds the documents to be signed in the system (1) through at least one input device (6) using a network (11), and also selects a preferable workflow (10) option.

The documents are approved by the internal departments, either by providing a declaration for validation of documents in form of checkbox acceptance or by defining a workflow (10) for approval by the internal team prior to entering at least one e-signing workflow (10), where the approved documents are hereafter referred to as “pre-approved” documents, and such approvals are captured in the audit report of the eSignature workflow transaction.

The signer (4) selects either a workflow-I or workflow-II from the e-signature feature (15), as per the requirement of the sender (3).

After following the selected workflow (10), the signer (4) selects the “apply sign” button in the e-signature feature (15).

An e-sign panel appears on the user interface (6), where the signer (4) provides consent to apply signature through a confirmation checkbox and selects a “submit to sign” option.

The signature is applied thereby completing the transaction, where after a “transaction confirmation email” is sent to the sender (3), signer (4) and recipient's (5) of the document.

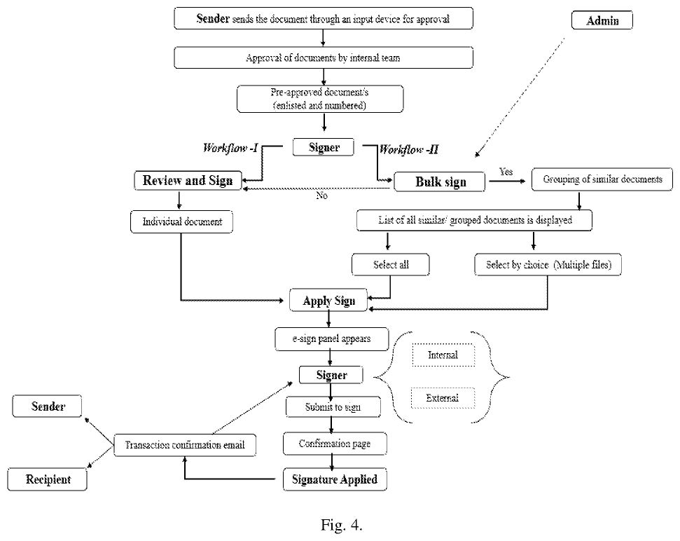

Another embodiment of the present invention describes the workflow-I as mentioned in the step 4 of the preferred method, as illustrated in FIG. 4. The “workflow-I” refers to “an individual e-signature workflow transaction” that enables individual signing of each pre-approved documents independently, using the following steps:

The signer (4) selects the option of “review and sign.”

It opens the individual signature workflow, where the signer (4) receives a link in an email notification for signing individual pre-approved document.

The signer (4) then proceeds to electronic signing of pre-approved documents following the steps 5-7 of the method of e-signing mentioned above.

Another embodiment of the present invention describes the workflow-II as mentioned in step 4 of the preferred method, as illustrated in FIG. 4. The “workflow-II” refers to “a bulk e-signature workflow transaction” that enables the internal signer (4) of the organization to sign multiple documents simultaneously, belonging to the same group from the pre-approved documents, using the following steps:

The signer (4) selects the option of “bulk sign,” that enables the signer (4) to apply signature to multiple documents in a single step.

The system (1) uses the metadata (14) field mapping in the e-signature feature (15) of the system (1) to group all the similar pre-approved documents in relevant groups using the information in the metadata (14) and displays the list of all groups in a summary window using a user interface (6).

In case the signer (4) has to sign all the documents displayed, he has to click on a “select all” option, whereas in case where the signer (4) has to sign multiple documents from the list of displayed documents, he has to opt for “selective signing” where the signer (4) has to select the required multiple documents therefrom.

The signer (4) then proceeds to electronic signing of pre-approved documents following steps 5-7 of the method of e-signing mentioned above.

Another embodiment of the present invention describes that the internal team for approving the documents includes, not limiting to, either a manager, a senior executive or a legal team that is authorized to review and approve the documents, and the signer (4) of the documents includes either an internal signer i.e. a signer within the same organization or an external signer i.e. a signer from a different organization.

Another embodiment of the invention describes the grouping within the e-signature feature (15) of the system (1). During the grouping of pre-approved documents for the convenience of bulk signing, the system (1) displays a list of meta data fields like-region, legal entity, business units, document type whether it is customer contract or vendor contract, transaction type, values and other fields, using a user interface (6). If the sender (3) selects any of these meta data fields on the user interface (6), then the system (1) groups different contracts/documents based on the selected metadata (14) fields depending on metadata (14) field mapping to the contracts, and shows a summary of the groupings done. The summary window allows the sender (3) to rearrange the groupings in case of a discrepancy in grouping any contract wrongly. Once the summary window grouping is sorted and finalized by the sender (3) by submitting a checkbox declaration of approval or validation, the grouped documents are triggered for bulk sign off process using a workflow-II of the system (1). Thus, as per the groupings of the documents based on the metadata (14) fields, the mapped signing workflow also gets mapped to each document.

### Advantages

The system (1) of the present invention provides auto-grouping of pre-approved documents based on metadata (14) field mapping providing flexibility in grouping of documents thereby allowing changing of the documents to different groups or applying the required signing workflows (10) alternatively. Further, the system (1) provides alternative options of “individual document signing” and “bulk signing” based on user requirement. The advanced “bulk signing” option in the e-signature feature (15) of the system (1) is time-saving, effortless and one-click-transaction approach over the individual signing through separate links in emails, as all the documents within a group are signed simultaneously.

### Example

### Grouping of the Documents and Bulk Signing

In an exemplary case where the sender selects a “bulk signature” workflow, the grouping of documents using the e-signature feature of the present system (1) can be more clearly understood from the example:

The sender sends the documents A, B, C, D, E, F, G, H, and I for applying signatures, all the documents shall be first approved by the internal team and sent to a signer for applying the signature. Now, say a few documents from A to I belong to a particular business unit location and the remaining documents belong to any other region. In this case, the sender selects a metadata field to which the documents belong, say a business unit location “New Jersey,” the system groups different contracts/documents based on the selected metadata fields depending on metadata field mapping to the contracts, and shows a summary of the groupings in a summary window enabling the sender to rearrange the groupings in case of any discrepancy in grouping. Here, the documents say A, B, C, D, and E, are placed into business unit location-“New Jersey” group as per the metadata field mapping of the e-signature feature of the system.

So, in this case of a business unit-based metadata grouping for the business unit location-“New Jersey,” the system assigns a signing workflow, either workflow-I for individual signing or workflow-II for multiple and bulk signing, for all of the documents within that group. Thus, the sender is not required to bother about manually setting signing workflow for each and every document of the group. Once the documents are placed within a certain group, automatically the “bulk signing” workflow gets applied to that grouping. Here, to the documents A, B, C, D and E, thus, grouped under business unit “New Jersey,” the selected signing workflow automatically applies to all the documents (A, B, C, D and E) within this group. The signer, say internal signer, need not add signing workflow manually for each and every document within the same group where a bulk sign option is opted. All the documents (A-E) are thereby simultaneously applied signature using the “bulk signing” option of the e-signature feature of the system, and the confirmation emails of the completed transactions would be sent to the sender, signer and recipient of the documents.

It is to be noted that the above scenario is only an example and the number of documents, metadata fields of grouping, selection of workflow may vary as per the scenario of every other transaction. Nevertheless, the example shall be used to understand the different embodiments of the present invention.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for auto-grouping and bulk signing of pre-approved documents, including an admin, a sender of the documents, a signer of the documents, a recipient of the documents, an input device, an output device, a pre-approved document and a signed document, a network connection and servers, comprising:
an e-signature feature of the system uses a processing means for employing a transaction workflow, wherein the admin enables the workflow options, the sender sends a pre-approved document to be signed, using an input device where a signer employs a workflow from the e-signature feature through a processing means and sends the signed documents to a recipient using an output device; and
wherein the pre-approved documents are grouped using the metadata field mapping and the signed documents are stored in at least one hosting server; and
wherein the system and method facilitates the auto-grouping, individual signing and bulk signing of the pre-approved documents within the same group, using the e-signature feature of the system by following the defined method including either an individual e-signature workflow transaction or a bulk e-signature transaction, that enables applying individual signature and bulk signature respectively, to the pre-approved documents.

2. The system as claimed in claim 1, wherein auto-grouping of the pre-approved documents for bulk signing within the e-signature feature of the system is done through metadata field mapping as the system displays a list of meta data fields including, and not limiting to—region, legal entity, business units, document type such as customer contract or vendor contract, transaction type, values and other fields, using a user interface;
wherein the system groups different contracts or documents based on the selected metadata fields depending on metadata field mapping to the contracts, and displays a list of the groupings done on a summary window allowing the sender to rearrange the groupings in case of any discrepancy in grouping thereby submitting a checkbox declaration of approval or validation so as to trigger the grouped documents for bulk sign off process using a workflow-II of the system.

3. The system as claimed in claim 1, wherein the system provides auto-grouping of pre-approved documents based on metadata field mapping, provides flexibility in grouping of documents, allows changing of the documents to different groups, allows application of alternative workflows including individual document signing and bulk signing based on user requirement thereby providing a time-saving, effortless and one-click-transaction approach over the individual signing through separate links in emails, allowing signing of all documents within a group simultaneously.

4. A method for auto-grouping and bulk signing of pre-approved documents, comprising the steps of:
providing a system according to claim 1;
i. enabling a bulk sign option by the admin from the system settings while initiating the transaction;
ii. adding the documents to be signed by the sender through at least one input device using a network;
iii. selecting a workflow option by the sender;
iv. approval of the documents by providing a declaration for validation of documents by the internal departments, whereafter the approved documents are referred to as pre-approved documents;
v. selecting either an individual e-signature workflow transaction or a bulk e-signature workflow transaction by the signer from the e-signature feature, as pre-decided by the sender (step c.);
vi. selecting the apply sign button by the signer from the e-signature feature, after following at least one workflow;
vii. providing consent to apply signature through a confirmation checkbox and selecting a submit to sign option on the e-sign panel appearing on the user interface;
viii. sending a transaction confirmation email to the sender, signer and recipients after the signature is applied; and
wherein as the signer selects an individual e-signature workflow transaction for signing each pre-approved document independently;
wherein the system follows the steps as:
i. selecting a review and sign option by the signer;
ii. clicking on the link received in an email notification by the signer, for signing the individual pre-approved document;
iii. following the steps (f to h) of the method of e-signing mentioned above to complete electronic signing of the individual pre-approved documents; and
wherein as the signer selects a bulk e-signature workflow transaction for signing multiple documents simultaneously, belonging to the same group from the pre-approved document, the system follows the steps as:
i. selecting a bulk sign option by the signer enabling the system to apply signature to multiple documents in a single step;
ii. grouping of all the similar pre-approved documents through metadata field mapping in relevant groups using the e-signature feature of the system;
iii. displaying the list of all groups as a summary window on the user interface;
iv. clicking on the select all option where the signer has to sign all the documents displayed, or alternatively clicking on the selective signing option where the signer has to select the required multiple documents from the list displayed in the summary window;
v. following the steps (f to h) of the method of e-signing mentioned above to complete electronic signing of the individual pre-approved documents.

5. The method as claimed in claim 4, wherein the internal team for approving the documents includes, not limiting to either a manager, a senior executive or a legal team that is authorized to review and approve the documents, and the signer of the documents includes either an internal signer or an external signer.

6. The method as claimed in claim 4, wherein the method provides auto-grouping of pre-approved documents based on metadata field mapping, provides flexibility in grouping of documents, allows changing of the documents to different groups, allows application of alternative workflows including individual document signing and bulk signing based on user requirement thereby providing a time-saving, effortless and one-click-transaction approach over the individual signing through separate links in emails, allowing signing of all documents within a group simultaneously.
